(19) United States
(12) Patent Application Publication
(10) Pub. No.: US 2022/0376295 A1
(43) Pub. Date: Nov. 24, 2022

(54) POLYMER ELECTROLYTE MEMBRANE, ELECTRODE STRUCTURE AND ELECTROCHEMICAL DEVICE INCLUDING SAME, AND METHOD FOR MANUFACTURING POLYMER ELECTROLYTE MEMBRANE

(71) Applicant: GRINERGY CO.LTD., Seoul (KR)

(72) Inventor: Byunghoon Chung, Seoul (KR)

(21) Appl. No.: 17/621,627

(22) PCT Filed: Jun. 26, 2019
(86) PCT No.: PCT/KR2019/007759

§ 371 Date: Dec. 21, 2021

(51) Int. Cl. H01M 10/0565; H01M 10/052; H01M 4/134; H01M 4/38; C08J 5/22

(52) U.S. Cl. CPC H01M 10/0565; H01M 10/052; H01M 4/134; H01M 4/382; C08J 5/2231; H01M 2300/0082; C08J 2335/02; C08J 2453/00

(57) ABSTRACT

A polymer electrolyte membrane, an electrode structure and an electrochemical device including the same, and a method of manufacturing the polymer electrode membrane are disclosed. The polymer electrolyte membrane includes a copolymer of a cross-linkable precursor comprising a urethane group-containing polyfunctional acrylic monomer and a polyfunctional block copolymer; and a lithium salt, thereby having high elasticity and high strength characteristics, so that dendrites can be stably protected and damage to a protective film can be prevented when the dendrites are grown on the surface of a lithium metal electrode during the charging and discharging of a battery, and thus the performance of the battery can be improved. The polymer electrolyte membrane can be directly coated on a free-standing type film or a lithium metal electrode and then molded into a form of protective film, and can thus be used in an electrochemical device such as a high-density and high-energy lithium metal battery.

### TECHNICAL FIELD

The present disclosure relates to a polymer electrolyte membrane, an electrode structure and an electrochemical device including the same, and a method of manufacturing the polymer electrode membrane.

### BACKGROUND ART

According to the trend of light, thin, compact and portable electric and electronic products, a secondary battery, which is a core component, is also required to be lightweight and miniaturized, and the development of a battery having high power and high energy density is required. In response to these requirements, one of the high-performance, next-generation, and high-tech new batteries having received the most spotlight recently is a lithium metal secondary battery.

However, since a lithium metal electrode used as an electrode has high reactivity with an electrolyte component, a passivation film is formed by reaction with an organic electrolyte, and the oxidation (dissolution) and reduction (deposition) reactions of lithium on the surface of a lithium metal are non-uniformly repeated during charging and discharging, so that the formation and growth of the passivation film are extremely occur. Accordingly, not only a decrease in capacity of the battery during charging and discharging, but also, as the charging and discharging process is repeated, dendrites in which lithium ions grow in the form of needles are formed on the surface of the lithium metal, thereby causing safety problems of the battery, such as reducing the charge-discharge cycle of the lithium secondary battery or causing a short between electrodes.

In order to solve the above problems, Korean Patent Registration No. 10-0425585 proposes a technology of forming a protective film by cross-linking a general chain polymer on the surface of a lithium electrode and coating the surface of lithium with the cross-linked polymer. However, due to the characteristics of the polymer, when the polymer contacts a small amount of an electrolyte, problems such as swelling and damage occurred. In the case of electrolytes containing a widely known ether-based polymer or PVDE (polyvinylidene fluoride), for example, PEO or PV and copolymers or mixtures containing the same, due to the low mechanical strength of the polymer, needle-shaped dendrites cannot be effectively blocked, and a protective film is damaged due to the continuous deposition of lithium dendrites, and thus the protective film cannot function normally.

Korean Patent Application Publication No. 2014-0083181 discloses a negative lithium electrode that forms a protective film containing inorganic particles on the surface of a lithium metal, and suggests that it is possible to stabilize the lithium metal and lower the interfacial resistance between a lithium electrode and an electrolyte. However, since the inorganic particles in the protective film are spherical particles, there is a problem in that lithium dendrites grow along the interface of the spherical particles, and there is still a risk of short circuit of a battery.

In order to solve this problem, a method of introducing a polymer protective film for inhibiting the growth of dendrites into a lithium metal electrode may be used. In this case, a protective film is formed by directly a protective film composition onto a lithium metal plate forming a negative electrode. However, in the case of direct coating on lithium metal using a general material, it is difficult to select a solvent due to the high reactivity of lithium metal, and residues remain after application, which may affect the performance of a battery including the negative electrode.

Therefore, there is a need for research on a new polymer material and method for forming a protective film on a lithium electrode.

### DESCRIPTION OF EMBODIMENTS

### Technical Problem

An aspect of the present disclosure is to provide a polymer electrolyte membrane capable of preventing damage to a protective film due to the growth of dendrites according to charging and discharging of the battery on the surface of a lithium metal electrode.

Another aspect of the present disclosure is to provide an electrode structure to which the polymer electrode membrane is applied.

Yet another aspect of the present disclosure is to provide an electrochemical device to which the polymer electrolyte member is applied.

Yet another aspect of the present disclosure is to provide a method of manufacturing the polymer electrode membrane.

### Solution to Problem

In an aspect of the present disclosure, there is provided a polymer electrolyte membrane comprising:

a copolymer of a cross-linkable precursor comprising a urethane group-containing polyfunctional acrylic monomer and a polyfunctional block copolymer; and

a lithium salt.

In another aspect, there is provided an electrode structure comprising:

a lithium metal electrode; and

a protective film provided on the lithium metal electrode and comprising the polymer electrolyte membrane.

In yet another aspect, there is provided an electrochemical device comprising:

the electrode structure.

In yet another aspect, there is provided a method of manufacturing a polymer electrolyte membrane, the method including:

preparing a precursor mixture comprising cross-linkable precursor including urethane group-containing polyfunctional acrylic monomer and a polyfunctional block copolymer, and a lithium salt; and

applying and curing the precursor mixture in a film shape.

### Advantageous Effects of Disclosure

Since a polymer electrolyte membrane according to an embodiment has high elasticity and high strength characteristics, it can stably protect dendrites during the growth of the dendrites on the surface of a lithium metal electrode according to the charging and discharging of a battery, can prevent damage to a protective film, and can improve the performance of the battery.

### BRIEF DESCRIPTION OF DRAWINGS

FIG. 1 is a graph showing the results of measuring the ionic conductivity of the polymer electrolyte membrane manufactured in Example 6.

FIG. 2 is a cross-sectional SEM image of a lithium metal electrode on which a protective film of the polymer electrolyte membrane obtained in Example 7 is formed before charging and discharging.

FIG. 3 is a cross-sectional SEM image of a lithium metal electrode on which a protective film of the polymer electrolyte membrane obtained in Example 7 is formed after charging and discharging.

### MODE OF DISCLOSURE

The present inventive concept described below can apply various transformations and can have various embodiments, and specific embodiments are illustrated in the drawings and described in detail in the detailed description. However, the present inventive concept may be embodied in many different forms, should not be construed as being limited to the embodiments set forth herein, and should be construed as including all modifications, equivalents, and alternatives within the scope of the present inventive concept.

The terms used herein is for the purpose of describing particular embodiments only and is not intended to be limiting of the inventive concept. Singular expressions include plural expressions unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the slash “/” or the term “and/or” includes any and all combinations of one or more of the associated listed items.

In the drawings, the thickness is enlarged or reduced in order to clearly express various layers and regions. Throughout the specification, the same reference numerals are attached to similar parts Throughout the specification, when an element such as a layer, a film, a region or a component is referred to as being “on” another layer or element, it can be “directly on” the other layer or element, or intervening layers, regions, or components may also be present. Although the terms “first”, “second”, “third”, etc., may be used herein to describe various elements, components, regions, and/or layers, these elements, components, regions, and/or layers should not be limited by these terms. These terms are used only to distinguish one component from another, not for purposes of limitation. Some of the components may be omitted in the drawings, but this is for helping the understanding of features of the invention and is not intended to exclude the omitted components.

Unless otherwise specified in the present specification, “substitution” means that at least one hydrogen atom is substituted with a substituent such as a halogen atom (F, Cl, Br, I), a C1 to C20 alkoxy group, a nitro group, a cyano group, an amino group, an imino group, an azido group, amidino group, a hydrazino group, a hydrazono group, a carbonyl group, a carbamyl group, a thiol group, an ester group, a carboxyl group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof.

Further, unless otherwise specified in the present specification, “hetero” means that at least one hetero atom of N, O, S and P is included in Formula.

Further, unless otherwise specified in the present specification, “(meth)acrylate” means that both “acrylate” and “methacrylate” are possible, and “(meth)acrylic acid” means that both “acrylic acid” and “methacrylic acid” are possible.

Hereinafter, an exemplary polymer electrolyte membrane, an electrode structure and an electrochemical device including the same, and a method of manufacturing the polymer electrode membrane will be described in more detail with reference to the attached drawings.

A polymer electrolyte membrane according to an embodiment includes:

a copolymer of a cross-linkable precursor comprising a urethane group-containing polyfunctional acrylic monomer and a polyfunctional block copolymer; and

a lithium salt.

The polymer electrolyte membrane includes a copolymer of a cross-linkable precursor including a urethane group-containing polyfunctional acrylic monomer and a polyfunctional block copolymer, and a lithium salt, so that it is possible to control the crystallinity of a polymer to maintain an amorphous state and to improve ionic conductivity and electrochemical properties. A cross-linked matrix prepared using a urethane group-containing polyfunctional acrylic monomer and a polyfunctional block copolymer as a main skeleton has very low crystallization of the polymer itself, and the movement of lithium ions due to the segmental motion of the polymer in an inner amorphous region is free, thereby improving ionic conductivity. In addition, a polymer electrolyte membrane having a free-standing level can be manufactured by improving the high mechanical properties of the copolymer itself with the polymer cross-linked structure.

The urethane group-containing polyfunctional acrylic monomer, as a cross-linkable precursor, may include diurethane dimethacrylate, diurethane diacrylate, or a combination thereof.

According to an embodiment, the urethane group-containing polyfunctional acrylic monomer may include diurethane dimethacrylate represented by Formula 1 below.

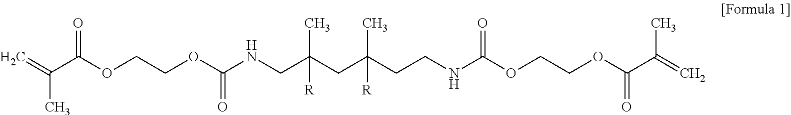

in Formula 1, each R is independently a hydrogen atom or a C1-C3 alkyl group.

Since the urethane group-containing polyfunctional acrylic monomer includes a urethane moiety to have high mechanical strength and high elasticity, when it forms a copolymerization structure together with the polyfunctional block copolymer, a polymer electrolyte membrane having elasticity while maintaining high mechanical strength can be manufactured.

In addition to the urethane group-containing polyfunctional acrylic monomer, other monomers including a polyfunctional functional group having a similar structure thereto may be additionally mixed and used. As the other monomers each including a polyfunctional functional group, for example, one or more selected from urethane acrylate methacrylate, urethane epoxy methacrylate, and Satomer N3DE180 and N3DF230 (products names of Arkema Corporation) may be used.

The polyfunctional block copolymer, as a cross-linkable precursor, may include (meth)acrylate groups at both ends thereof, and may include a diblock copolymer or a triblock copolymer including a polyethylene oxide repeating unit and a polypropylene oxide repeating unit.

According to an embodiment, the polyfunctional block copolymer may include (meth)acrylate groups at both ends thereof, and may include a triblock copolymer having a polyethylene oxide first block, a polypropylene oxide second block, and a polyethylene oxide third block,

According to an embodiment, the polyfunctional block copolymer may be represented by Formula 2 below.

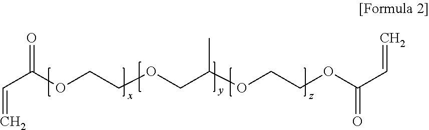

in Formula 2, x, y, and z are each independently an integer of 1 to 50.

The polyfunctional block copolymer of the above structure is similar in structure to polyethylene glycol dimethacrylate (PEGDMA), which is widely known in the art. However, in the case of PEGDMA, it has high degree of crystallinity due to a single linear structure, and a crack phenomenon may occur depending on degree of cross-linking after cross-linking polymerization. In contrast, the polyfunctional block copolymer has a block copolymer structure of propylene oxide and ethylene oxide, so that the crystallinity appearing in a single structure of ethylene oxide may be broken, and the polymer electrolyte membrane may additionally have flexibility due to two different polymer blocks.

The weight average molecular weight (Mw) of the polyfunctional block copolymer may be in the range of 500 to 20,000. For example, the weight average molecular weight (Mw) of the polyfunctional block copolymer may be in the range of 1,000 to 20,000, or 1,000 to 10,000. When the weight average molecular weight (Mw) of the polyfunctional block copolymer is within the above range, since the length of the block copolymer itself is appropriate, the polymer may not change brittle after cross-linking, and may be easy to control the viscosity and thickness when coating the lithium metal electrode without using a solvent.

The weight ratio of the urethane group-containing polyfunctional acrylic monomer and the polyfunctional block copolymer may be in the range of 1:100 to 100:1. For example, the weight ratio of the urethane group-containing polyfunctional acrylic monomer and the polyfunctional block copolymer may be in the range of 1:10 to 10:1. For example, the weight ratio of the urethane group-containing polyfunctional acrylic monomer and the polyfunctional block copolymer may be in the range of 1:5 to 5:1. Within the above range, it is possible to maintain an amorphous state by controlling the crystallinity of the polymer, and to improve ionic conductivity and electrochemical properties.

In addition to the polyfunctional block copolymer, other monomers or polymers having a similar structure thereto may be additionally mixed and used. Examples of the other monomers or polymers may include, but are not limited to, dipentaerythritol penta-/hexa-acrylate, glycerol propoxylate triacrylate, di(trimethylolpropane) tetraacrylate, trimethylolpropane ethoxylate triacrylate, and poly(ethylene glycol) methyl ether acrylate. One or more selected therefrom may be used.

According to an embodiment, in the polymer electrolyte membrane, an oligomer may be further added and copolymerized with the cross-linkable precursor in order to improve segmental motion of the copolymer and smooth movement of lithium ions. When the oligomer is added, flexibility of a polymer chain and an interaction between the ions and the polymer are facilitated by the low-molecular-weight oligomer compared to the polymer, so that the movement of lithium ions can be made faster, and thus the ionic conductivity of the polymer electrolyte membrane can be further improved.

The oligomer that may be used together with the cross-linkable precursor may have a weight average molecular weight (Mw) in the range of 200 to 600. The oligomer may include an ether-based oligomer, an acrylate-based oligomer, a ketone-based oligomer, or a combination thereof, In addition, the oligomer may include an alkyl group, an allyl group, a carboxyl group, or a combination thereof as a functional group. These functional groups are not reactive with lithium metal, and are electrochemically stable. On the other hand, a structure including —OH, —COOH, or —SO3H in an end group is not suitable. This is because this end group is reactive with lithium metal and is not electrochemically stable either.

As the oligomer, for example, PEG-based diglyme (di-ethylelen glycol), triglyme (tri-ethylelen glycol), tetraglyme (tetra ethylene glycol), or the like may be used.

The amount of the oligomer added may be 1 to 100 parts by weight based on 100 parts by weight of the total weight of the urethane group-containing polyfunctional acrylic monomer and the polyfunctional block copolymer. Within the above range, the physical properties of the copolymer itself do not deteriorate and the cross-linked matrix thereof does not loosen, the mechanical strength, heat resistance, and chemical stability of the copolymer can be maintained, and the shape of the polymer electrolyte membrane can also be stably maintained even at high temperatures.

The lithium salt serves to secure an ion conduction path of the polymer electrolyte membrane. The lithium salt may be used without limitation as long as it is commonly used in the art. For example, the lithium salt may include at least one selected from LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂, but examples thereof are not limited thereto.

The content of the lithium salt included in the polymer electrolyte membrane is not particularly limited, but may be, for example, 1 wt % to 50 wt % based on the total weight of the copolymer and the lithium salt. For example, the content of the lithium salt may be 5 wt % to 50 wt %, specifically, 10 wt % to 30 wt %, based on the total weight of the copolymer and the lithium salt. Within the above range, lithium-ion mobility and ion conductivity may be excellent.

The polymer electrolyte membrane may further include one or more selected from a liquid electrolyte, a solid electrolyte, a gel electrolyte, a polymer ionic liquid, and a separator, and as a result, the ionic conductivity and mechanical properties of the electrolyte may be further improved.

According to an embodiment, the polymer electrolyte membrane may further include a liquid electrolyte to further form an ion conductive path through the polymer electrolyte membrane.

The liquid electrolyte further includes one or more selected from an organic solvent, an ionic liquid, an alkali metal salt, and an alkaline earth metal salt. Examples of the organic solvent include a carbonate-based compound, a glyme-based compound, a dioxolane-based compound, dimethyl ether, and 1,1,2,2-tetrafluoroethyl 2,2,3,3-tetrafluoropropyl ether.

When a liquid electrolyte containing an organic solvent such as a carbonate-based compound is used together, the polymer electrolyte membrane may be very stable to an organic solvent such as a carbonate-based compound or an electrolyte containing the same.

The polymer electrolyte membrane includes a copolymer of a cross-linkable precursor including a urethane group-containing polyfunctional acrylic monomer and a polyfunctional block copolymer, and a lithium salt, so that it is possible to control the crystallinity of a polymer to maintain an amorphous state and to improve ionic conductivity and electrochemical properties. In addition, a polymer electrolyte membrane having a free-standing level can be manufactured by improving the high mechanical properties of the copolymer itself with the polymer cross-linked structure. The polymer electrolyte membrane may maintain a free-standing film at 25° C. to 60° C.

The ionic conductivity (a) of the polymer electrolyte membrane may be 1×10⁻⁵ S/cm to 1×10⁻³ S/cm at room temperature and 25° C. to 60° C.

The polymer electrolyte membrane may be produced in the form of a protective film by direct coating of a free-standing film or a lithium metal electrode to minimize an interface between the lithium metal electrode and the protective film.

As described above, the polymer electrolyte membrane has excellent ionic conductivity and mechanical strength, and may thus be implement as an electrolyte membrane that may be used in an electrochemical device such as a high-density and high-energy lithium secondary battery using a lithium metal electrode. In addition, when the polymer electrolyte membrane is used, there is no leakage, there is no electrochemical side reaction that occurs at a negative electrode and a positive electrode, there is no electrolyte decomposition reaction unlike an electrolyte using a liquid electrolyte, battery characteristics can be improved, and battery stability can be secured.

An electrode structure according to an embodiment includes:

a lithium metal electrode; and

a protective film provided on the lithium metal electrode and including the above-described polymer electrolyte membrane.

The thickness of the lithium metal electrode may be 100 □m or less, for example, 80 □m or less, 50 □m or less, 30 □m or less, or 20 □m or less. According to another embodiment, the thickness of the lithium metal electrode may be 0.1 □m to 60 □m. Specifically, the thickness of the lithium metal electrode may be 1 □m to 25 □m, for example, 5 □m to 20 □m.

The protective film provided on the lithium metal electrode includes the above-described polymer electrolyte membrane. Since the protective film including the polymer electrolyte membrane has high ionic conductivity and mechanical strength even at room temperature and high temperature, it is possible to form an electrode structure effectively applicable to a battery while suppressing dendrites on the surface of the lithium metal electrode.

In the case of a protective film made of a known material, during charging and discharging, dendrites accumulate on a lithium metal electrode and grow through the protective film, which caused an internal short circuit or battery lifespan reduction. However, in the case of the polymer electrolyte membrane, the elasticity thereof is very good, so even if the volume of the surface of the lithium metal electrode is expanded during dendrite deposition, the protective film can also be stretched due to the elastomeric properties of the polymer electrolyte membrane, and thus the protective film itself may be covering the dendrite without being torn or pierced. As a result, the polymer electrolyte membrane can continuously maintain its shape even during charging and discharging, and can safely cover the dendrite even when the dendrite grows, thereby preventing an internal short circuit caused by the dendrite, to improve battery lifespan and secure battery stability.

An electrochemical device includes the above-described electrode structure.

The electrochemical device uses the polymer electrolyte membrane as a protective film to have excellent safety and high energy density, maintains the characteristics of a battery even at a temperature of 60° C. or higher, and enables the operation of all electronic products even at such a high temperature.

The electrochemical device may be a lithium secondary battery such as a lithium-ion battery, a lithium polymer battery, a lithium air battery, or a lithium all-solid-state battery.

The electrochemical device to which the solid polymer electrolyte is applied is suitable for applications requiring high-capacity, high-output and high-temperature operation, such as electric vehicles, in addition to conventional mobile phones and portable computers, and may be used in hybrid vehicles and the like in combination with conventional internal combustion engines and fuel cells, supercapacitors, and the like. In addition, the electrochemical device may be used in all other applications requiring high output, high voltage and high temperature driving.

Hereinafter, a method of manufacturing a polymer electrolyte membrane according to an embodiment will be described.

A method of manufacturing a polymer electrolyte membrane according to an embodiment includes: preparing a precursor mixture including cross-linkable precursor including a urethane group-containing polyfunctional acrylic monomer and a polyfunctional block copolymer, and a lithium salt; and applying and curing the precursor mixture in a film shape.

The cross-linkable precursor including a urethane group-containing polyfunctional acrylic monomer and a polyfunctional block copolymer, and the lithium salt have been described as above.

The precursor mixture may further include a cross-linking agent, a photoinitiator, or the like to help the cross-linkage of the cross-linkable precursor. The content of the cross-linking agent, the photoinitiator, or the like may be in a commercially available range, for example, may be used in the range of 1 to 5 parts by weight based on 100 parts by weight of the cross-linkable precursor.

According to an embodiment, the precursor mixture may further include an initiator to form a copolymer having a crosslinked structure with the cross-linking agent. As the initiator, for example, thermal initiators such as peroxide (—O—O—)-based benzoyl peroxide, acetyl peroxide, dilauryl peroxide, di-tert-butyl peroxide, cumyl hydroperoxide, etc. or azo-based compound (—N═N—)-based azobisiso butyronitrile, azobisisovaleronitrile may be used.

When the precursor mixture including the cross-linkable precursor and the lithium salt is prepared, the precursor mixture is applied and cured in the form of a film to form a polymer electrolyte membrane. The precursor mixture may be applied in the form of a film without using a solvent, in a state of including the cross-linkable precursor, an optional initiator, and a lithium salt.

The method of applying the precursor mixture in the form of a film is various, and is not particularly limited. For example, the precursor mixture may be injected between two glass plates, and a pressure may be applied to the glass plates using a clamp to enable the control of the thickness of the electrolyte membrane. As another example, the precursor mixture may be directly applied on the lithium metal electrode using an application device such as spin coater to form a thin film having a predetermined thickness.

In the process of applying the precursor mixture, coating may be performed using deposition equipment such as a gravure coater, a reverse roll coater, a slit die coater, a screen coater, a spin coater, or a doctor blade.

The coating thickness may be in the range of 1 □m to 10 □m. When the coating thickness is less than 1 □m, there is a problem of tearing the polymer electrolyte membrane during dendrite growth, and when the coating thickness exceeds 10 □m, the properties of the polymer electrolyte membrane may be deteriorated as resistance increases depending on the thickness.

As the method of curing the precursor mixture, a curing method using UV, heat, or high energy radiation (electron beam, γ-ray) may be used. According to an embodiment, the polymer electrolyte membrane may be manufactured by directly irradiating the precursor mixture with UV (365 nm) or heat-treating the precursor mixture at about 60° C.

Hereinafter, exemplary embodiments will be described in more detail through the following examples and comparative examples. However, these embodiments are intended to illustrate technical ideas, and the scope of the present disclosure is not limited thereto.

### Example 1

5 g of diurethane dimethacrylate (DUDMA) (Sigma-Aldrich, 470.56/mol) of Formula 1 above and 2 g of poly(ethylene glycol)-block-poly(propylene glycol)-block-poly(ethylene glycol) diacrylate (PPG-b-PEG) (Sigma-Aldrich, average Mn ˜1200) of Formula 1 above were mixed in a vial and stirred for 10 minutes, and then 0.7 g of lithium salt LiFSI (lithium bis(fluorosulfonyl)imide) was put into the vial, followed by mixing again. Initiator BEE (benzoin ethyl ether, Sigma-Aldrich, 240.30 g/mol) was added to the resulting mixture in an amount of 1% based on the total weight of the mixture, followed by stirring and mixing again, to prepare a gel precursor mixture.

0.2 g of the gel precursor mixture was placed on a glass plate, covered with another glass plate, and then irradiated with 365 nm UV for 50 seconds to manufacture a transparent polymer electrolyte membrane having a thickness of 20 Dm.

### Example 2

A polymer electrolyte membrane was manufactured in the same manner as in Example 1, except that the contents of DUDMA and PPG-b-PEG was adjusted to 3 g and 3 g, respectively.

### Example 3

A polymer electrolyte membrane was manufactured in the same manner as in Example 1, except that the contents of DUDMA and PPG-b-PEG was adjusted to 2 g and 5 g, respectively.

### Example 4

A polymer electrolyte membrane was manufactured in the same manner as in Example 1, except that 5 g of ether-based oligomer triethylene glycol dimethyl ether (TEGDME) was additionally mixed with the mixture, and 0.5 g of lithium salt LiFSI (lithium bis(fluorosulfonyl)imide) was used.

### Example 5

A polymer electrolyte membrane was manufactured in the same manner as in Example 4, except that an ethylene carbonate (EC) electrolyte containing 1M LiFSI salt was used instead of the ether-based oligomer.

### Example 6

A polymer electrolyte membrane was manufactured by performing the same process as in Example 5 while changing the amount of the electrolyte added to 0 g, 0.7 g, 2.1 g, 3.5 g, 4.9 g, 6.4 g, and 7.0 g, and ionic conductivity of the polymer electrolyte membrane was evaluated. The amount of each electrolyte added corresponds to 0, 10, 30, 50, 70, 90 and 100 parts by weight based on 100 parts by weight of the total weight of DUDMA and PPG-b-PEG.

### Example 7

The gel precursor mixture prepared in Example 1 was applied on a Cu film having a thickness of about ˜2 □m, which had been vacuum-deposited on the surface of a Si wafer by spin coating rather than pressing between glass plates, and irradiated with 365 nm UV for 50 seconds to manufacture a transparent polymer electrolyte membrane having a thickness of about 2 □m to about 5 □m.

### Comparative Example 1

A polymer electrolyte membrane was manufactured in the same manner as in Example 1, except that the contents of DUDMA and PPG-b-PEG was adjusted to 0 g and 5 g, respectively.

### Evaluation Example 1: Evaluation of Ionic Conductivity

Ionic conductivity of the polymer electrolyte membranes manufactured in Examples 1 to 4 and Comparative Example 1 was measured, and the results thereof are shown in Table 1 below. The ionic conductivity was evaluated by measuring a frequency range of 1 Hz to 1 MHz using a Solatron 1260A Impedance/Gain-Phase Analyzer in a state of placing a sample between two SUS disks having an area of 1 cm² and then applying a constant pressure to a spring from both sides thereof.

TABLE 1

| | Example | Example | Example | Example |
|---|---|---|---|---|
| | 1 | 2 | 3 | 4 |
| DUDMA/PPG-b-PEG | 5 g/2 g | 3 g/3 g | 2 g/5 g | 5 g/2 g |
| TEGDME | — | — | — | 5 g |
| Ionic conductivity at | 7.40E−05 | 8.30E−05 | 8.8E−05 | 8.23E−05 |
| room temperature | | | | |

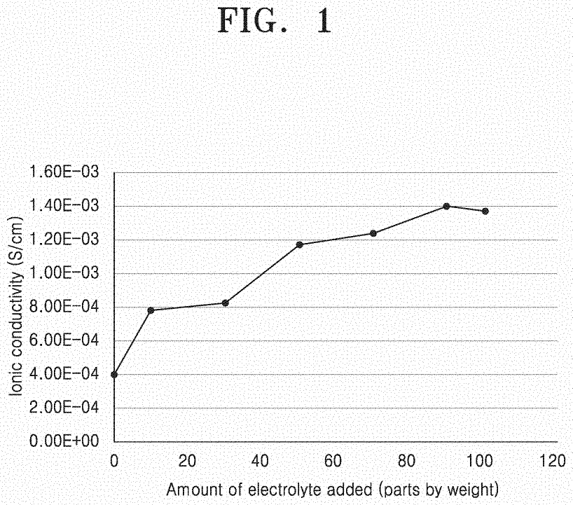

As shown in Table 1, in the polymer electrolyte membranes manufactured in Examples 1 to 4 and Comparative Example 1, there is a difference in ionic conductivity depending on the content ratio of DUDMA and PPG-b-PEG, but the state of the electrolyte membrane after ion conductivity measurement was good with no significant change. The manufactured electrolyte membranes tend to be somewhat brittle depending on the content of DUDMA, and in the case of Example 1 containing the most amount of DUDMA and in the case of Comparative Example 1 (Example 4) containing no DUDMA, there was a great difference in terms of flexibility of the membrane. The membrane manufactured by crosslinking the composition of only PPG-b-PEG without DUDMA was very soft, and was not suitable for free standing. This phenomenon is thought to be a difference depending on the density and structure of the polymer after crosslinking and the structure of DUDMA itself. In the case of Example 2, it is though that DUDMA has a linear structure in terms of polymer structure, whereas PPG-b-PEG has a block copolymer structure having more flexible properties. Meanwhile, in order to confirm the characteristics of the polymer electrolyte membrane manufactured by the addition of EC containing a 1M LiFSI salt as a liquid electrolyte for ion batteries instead of TEGDME, ionic conductivity of the polymer electrolyte membrane manufactured in Example 6 was measured, and the results thereof are shown in FIG. 1.

As shown in FIG. 1, it can be seen that the ionic conductivity is improved as the content of the electrolyte is increased as in the case of a general polymer electrolyte. However, it was confirmed that unlike a general gel-type polymer, the shape of the polymer electrolyte membrane manufactured according to the present disclosure was not damaged due to excessive swelling even when it was impregnated with a large amount of electrolyte or a large amount of electrolyte was added thereto. From this, it is thought that the same effect can be expected when the polymer electrolyte membrane is applied to the lithium metal electrode as a protective film.

### Evaluation Example 2: Evaluation of Film State Before and After Charging and Discharging

In order to confirm the function as a protective film of the polymer electrolyte membrane manufactured in Example 7, A PE separator (Celgard, Celgard 3501) and a positive electrode were sequentially stacked on the polymer electrolyte membrane obtained in Example 7, and then the stacked polymer electrolyte membrane was put into an aluminum pouch and vacuum-packed to prepare a cell. Here, the positive electrode was prepared as follows, and was sufficiently impregnated in the EC electrolyte in which 1.3M LiPF6 was dissolved in advance. For manufacturing the positive electrode, first, LiCoO₂, a conductive agent (Super-P; Timcal Ltd.), polyvinylidene fluoride (PVdF), and N-pyrrolidone were mixed to obtain a positive electrode composition. The mixing weight ratio of LiCoO₂, a conductive agent and PVdF in the positive electrode composition was 97:1.5:1.5. The positive electrode composition was applied onto an aluminum foil (thickness: about 15 □m) and dried at 25° C., and then the dried product was further dried at about 110° C. under vacuum to prepare a positive electrode.

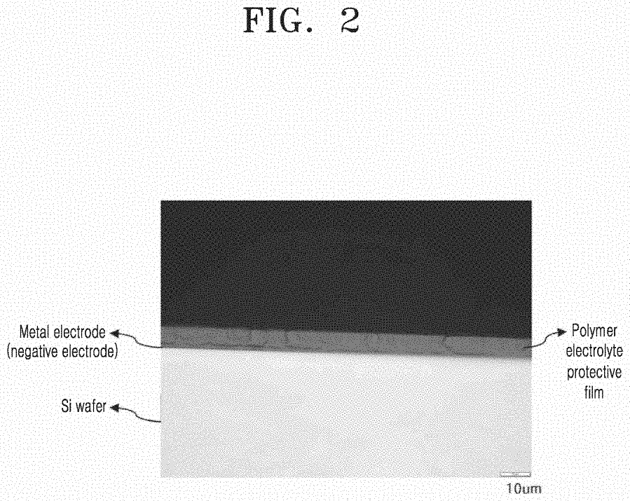

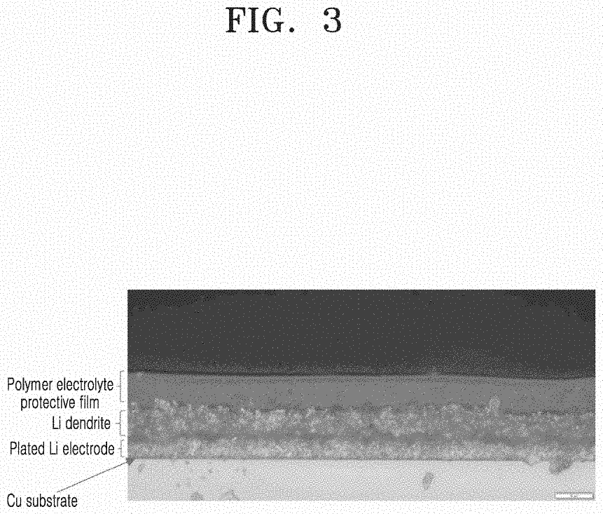

For the cell, after two formation cycles with a current of 0.05C rate, CC-CV charging and discharging were performed 50 times with a current of 0.5C rate, SEM photographs of a cross-section of a negative electrode including the polymer electrolyte membrane before and after charging and discharging are shown in FIGS. 2 and 3, respectively.

As shown in FIG. 2, it may be found that the Cu metal electrode is applied on the Si wafer, and a polymer electrolyte protective film is formed thereon to a thickness of about 5 □m.

As shown in FIG. 2, it may be seen that After charging and discharging of the cell 50 times, Li⁺ derived from a positive electrode active material is plated on the surface of the Cu metal electrode to form a lithium metal electrode, and lithium dendrites are deposited thereon and located under the polymer electrolyte membrane. However, it may be seen that the polymer electrolyte membrane is not torn or pierced due to its elasticity even when the volume of the electrode surface is expanded due to the precipitation of such dendrites, its shape is continuously maintained, and the polymer electrolyte membrane safely covers the dendrites.

From the above results, it may be found that the polymer electrolyte membrane according to an embodiment has superior ionic conductivity at room temperature and high temperature compared to generally well-known polymer electrolytes using PEO, PVDF, or PEGDMA as a main chain, and in particular, exhibits excellent mechanically stable properties for maintaining the shape and characteristics of the polymer electrolyte membrane without deterioration of membrane properties due to excessive electrolyte impregnation or damage due to volume expansion.

Heretofore, preferred embodiments according to the present disclosure have been described with reference to the drawings and examples, but it will be understood that these embodiments are merely exemplary, and various modifications and equivalent other embodiments are possible by those skilled in the art. Accordingly, protection scope of the present disclosure should be defined by the appended claims.

1. A polymer electrolyte membrane for a lithium metal electrode, the membrane comprising: a copolymer of a cross-linkable precursor comprising a urethane group-containing polyfunctional acrylic monomer and a polyfunctional block copolymer; and
a lithium salt.

2. The polymer electrolyte membrane of claim 1, wherein the urethane group-containing polyfunctional acrylic monomer comprises diurethane dimethacrylate, diurethane diacrylate, or a combination thereof.

3. The polymer electrolyte membrane of claim 1, wherein the urethane group-containing polyfunctional acrylic monomer comprises diurethane dimethacrylate represented by Formula 1 below: 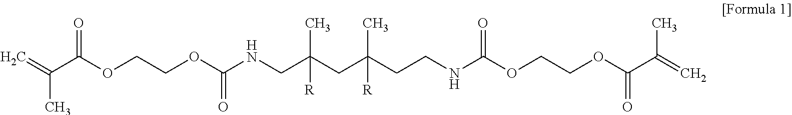
in Formula 1, each R is independently a hydrogen atom or a C1-C3 alkyl group.

4. The polymer electrolyte membrane of claim 1, wherein the polyfunctional block copolymer comprises (meth)acrylate groups at both ends thereof, and comprises a diblock copolymer or a triblock copolymer comprising a polyethylene oxide repeating unit and a polypropylene oxide repeating unit.

5. The polymer electrolyte membrane of claim 1, wherein the polyfunctional block copolymer comprises a polymer represented by Formula 2: 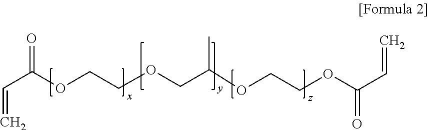
in Formula 2, x, y, and z are each independently an integer of 1 to 50.

6. The polymer electrolyte membrane of claim 1, wherein the polyfunctional block copolymer has a weight average molecular weight (Mw) ranging from 500 to 20,000.

7. The polymer electrolyte membrane of claim 1, wherein a weight ratio of the urethane group-containing polyfunctional acrylic monomer and the polyfunctional block copolymer is in a range of 1:100 to 100:1.

8. The polymer electrolyte membrane of claim 1, wherein a weight ratio of the urethane group-containing polyfunctional acrylic monomer and the polyfunctional block copolymer is in a range of 1:10 to 10:1.

9. The polymer electrolyte membrane of claim 1, wherein the copolymer is obtained by copolymerizing the cross-linkable precursor with an oligomer having a weight average molecular weight (Mw) ranging from 200 to 600.

10. The polymer electrolyte membrane of claim 8, wherein the oligomer comprises an ether-based oligomer, an acrylate-based oligomer, a ketone-based oligomer, or a combination thereof, and comprises an alkyl group, an allyl group, a carboxyl group, or a combination thereof as a functional group.

11. The polymer electrolyte membrane of claim 1, wherein the lithium salt comprises at least one selected from LiSCN, LiN(CN)₂, LiClO₄, LiBF₄, LiAsF₆, LiPF₆, LiCF₃SO₃, LiC(CF₃SO₂)₃, LiN(SO₂C₂F₅)₂, LiN(SO₂CF₃)₂, LiN(SO₂F)₂, LiSbF₆, LiPF₃(CF₂CF₃)₃, LiPF₃(CF₃)₃, and LiB(C₂O₄)₂.

12. The polymer electrolyte membrane of claim 1, wherein a content of the lithium salt is 1 wt % to 50 wt % based on a total weight of the copolymer and the lithium salt.

13. The polymer electrolyte membrane of claim 1, wherein the polymer electrolyte membrane maintained as a free-standing film at 25° C. to 60° C.

14. The polymer electrolyte membrane of claim 1, further comprising:
at least one selected from a liquid electrolyte, a solid electrolyte, a gel electrolyte, a polymer ionic liquid, and a separator.

15. An electrode structure comprising:
a lithium metal electrode; and
a protective film provided on the lithium metal electrode and comprising the polymer electrolyte membrane of claim 1.

16. An electrochemical device comprising the electrode structure of claim 15.

17. A method of manufacturing a polymer electrolyte membrane of claim 1, the method comprising:
preparing a precursor mixture comprising cross-linkable precursor including urethane group-containing polyfunctional acrylic monomer and a polyfunctional block copolymer, and a lithium salt; and
applying and curing the precursor mixture in a film shape.

18. The method of claim 17, wherein the urethane group-containing polyfunctional acrylic monomer includes diurethane dimethacrylate, diurethane diacrylate, or a combination thereof.

19. The method of claim 17, wherein the urethane group-containing polyfunctional acrylic monomer comprises diurethane dimethacrylate represented by Formula 1 below: 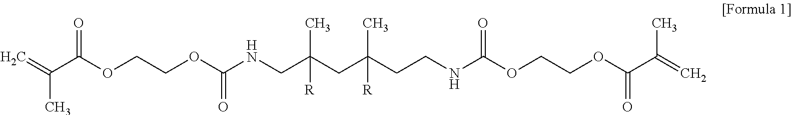
in Formula 1, each R is independently a hydrogen atom or a C1-C3 alkyl group.

20. The method of claim 17, wherein the polyfunctional block copolymer comprises (meth)acrylate groups at both ends thereof, and comprises a diblock copolymer or a triblock copolymer comprising a polyethylene oxide repeating unit and a polypropylene oxide repeating unit.

21. The method of claim 17, wherein the polyfunctional block copolymer comprises a polymer represented by Formula 2: 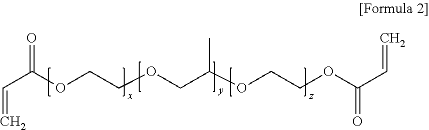
in Formula 2, x, y, and z are each independently an integer of 1 to 50.

22. The method of claim 17, wherein the curing of the precursor mixture is performed using UV, heat, or high-energy radiation.
